(19) United States
(12) Patent Application Publication
(10) Pub. No.: US 2018/0278645 A1
(43) Pub. Date: Sep. 27, 2018

(54) SOFTWARE EVALUATION METHOD AND SOFTWARE EVALUATION DEVICE

(71) Applicant: FUJITSU LIMITED, Kawasaki-shi (JP)

(72) Inventors: Kota Yamakoshi, Ota (JP); Masaru Nishiyama, Hachioji (JP)

(73) Assignee: FUJITSU LIMITED, Kawasaki-shi (JP)

(21) Appl. No.: 15/920,117

(22) Filed: Mar. 13, 2018

(30) Foreign Application Priority Data
Mar. 21, 2017 (JP) 2017-054621

(51) Int. Cl. H04L 29/06

(52) U.S. Cl. CPC H04L 63/1458; H04L 2463/142

(57) ABSTRACT

A software evaluation method includes obtaining a number of requests from a transmission source other than a transmission source registered in advance from among requests to software, and at least one of an log output amount of logs output through the software and a number of log outputs of the logs, and generating information on evaluation of the software in accordance with the obtained number of requests and at least one of the obtained log output amount and the obtained number of log outputs.

### CROSS-REFERENCE TO RELATED APPLICATION

This application is based upon and claims the benefit of priority of the prior Japanese Patent Application No. 2017-54621, filed on Mar. 21, 2017, the entire contents of which are incorporated herein by reference.

### FIELD

The embodiments discussed herein are related to a software evaluation technology.

### BACKGROUND

Logging as a Service (LaaS) in which logs are managed and monitored has been used as one of the services provided by a cloud operator.

Logs to record a behavior and a failure of an application developed by a user are stored for a specific time period. The Logs may be used, after the service has been utilized, for checking and analyzing the status, investigating at the time of occurrence of a trouble, or the like.

The LaaS standardize output and management of logs when a user develops an application on the cloud. By employing the LaaS, simplification of implementation and operational design of logs related to application development is expected to be achieved.

Meanwhile, the LaaS may receive, from the outside, an attack (for example, a Denial of Service (DoS) attack) against a web service provided from the cloud or the like. For the service on the cloud by using the LaaS, a scheme has been widely used in which two or more users share a single system and a resource, which is called a multi-tenant scheme.

Therefore, when the LaaS has been stopped due to an attack from the outside, impacts such as log missing affects many users of the service. Thus, it is desirable that a DoS attack against the LaaS be detected and dealt with.

As a related art, a technology has been proposed in which it is determined whether mass accesses have occurred in accordance with the number of accesses (for example, see Japanese Laid-open Patent Publication No. 2006-228140).

In addition, as a relate art, a technology has been proposed in which distribution of events, on a time axis, which belong to a parameter in a log are converted into distribution on a frequency axis to perform log analysis in which the periodicity of an attack is taken into account (for example, see Japanese Laid-open Patent Publication No. 2005-151289).

In addition, as a related art, a technology has been proposed in which logs are received from firewall (FW) and an illegal intrusion detection device, and a change amount of data related to events included in the logs is obtained (for example, see Japanese Laid-open Patent Publication No. 2006-18527).

In addition, as a related art, a technology has been proposed in which received packets are discarded in accordance with a specific thinning-out condition corresponding to a processing capacity when a packet accumulation amount reaches or passes a threshold value (for example, see Japanese Laid-open Patent Publication No. 2004-248198).

### SUMMARY

According to an aspect of the invention, a software evaluation method includes obtaining a number of requests from a transmission source other than a transmission source registered in advance from among requests to software, and at least one of an log output amount of logs output through the software and a number of log outputs of the logs, and generating information on evaluation of the software in accordance with the obtained number of requests and at least one of the obtained log output amount and the obtained number of log outputs.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of the overall configuration of a system according to an embodiment;

FIG. 2 is a diagram illustrating the first example of an attack against LaaS;

FIG. 3 is a diagram illustrating the second example of an attack against the LaaS;

FIG. 4 is a diagram illustrating the third example of an attack against the LaaS;

FIG. 5 is a diagram illustrating an example of a log monitoring server;

FIG. 6 is a diagram illustrating an example of application management information;

FIG. 7 is a diagram illustrating an example of log output amount classification information;

FIG. 8 is a diagram illustrating an example of log output number classification information;

FIG. 9 is a diagram illustrating an example of log output distribution information;

FIG. 10 is a diagram illustrating an example of maximum log storage amount setting information;

FIGS. 11A and 11B are diagrams illustrating an example of a generation method of a threshold value for the number of outputs;

FIGS. 12A to 12C are diagrams illustrating an example of a generation method of a threshold value for a pair of the number of log outputs and a log output amount;

FIG. 13 is a flowchart illustrating an example of request detection processing;

FIG. 14 is a flowchart illustrating an example of log output detection processing;

FIG. 15 is the first flowchart illustrating an example of log monitoring processing;

FIG. 16 is the second flowchart illustrating the example of the log monitoring processing;

FIG. 17 is the third flowchart illustrating the example of the log monitoring processing; and

FIG. 18 is a diagram illustrating an example of a hardware configuration of the log monitoring server.

### DESCRIPTION OF EMBODIMENTS

In the related art, for example, it may be determined that the LaaS has received an attack when a log output amount relating to requests from a specific host is large. Meanwhile, a lot of requests may be received, for example, when unmalicious software is used by many users. In this case, a lot of log output requests from a single piece of software are executed for the LaaS. Thus, when occurrence of an attack is determined only in accordance with a log output amount, unmalicious software is evaluated to be malicious software by mistake.

### Example of the Overall Configuration of a System According to an Embodiment

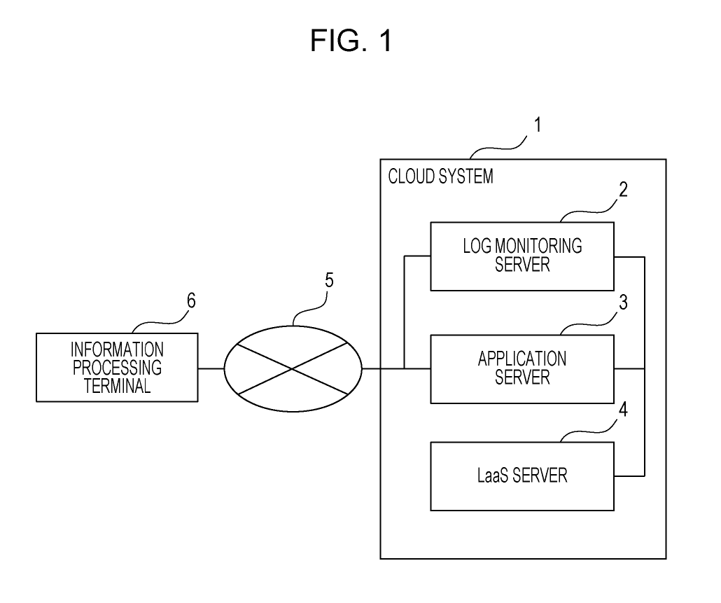

An embodiment of the technology discussed herein is described below with reference to the drawings. FIG. 1 is a diagram illustrating an example of the overall configuration of the system according to the embodiment. The system according to the embodiment includes a cloud system 1, a network 5, and an information processing terminal 6.

The cloud system 1 includes a log monitoring server 2, an application server 3, and a LaaS server 4. The log monitoring server 2, the application server 3, and the LaaS server 4 may communicate with one another through a network such as a local area network (LAN).

The log monitoring server 2 monitors logs related to an application stored in the application server 3. Examples of the log monitoring server 2 include an information processing device and a computer.

The application server 3 stores software (application) that has been developed by a user. The application server 3 is, for example, a server used for Platform as a Service (PaaS), which may store an application that has been developed on a platform provided by the application server 3.

The LaaS server 4 stores and manages the logs related to the application stored in the application server 3.

The information processing terminal 6 communicates with the application server 3 through the network 5. The information processing terminal 6 transmits a request to the application stored in the application server 3 in response to an operation of the user.

The system according to the embodiment is not limited to the example illustrated in FIG. 1. For example, in FIG. 1, the single log monitoring server 2, the single application server 3, the single LaaS server 4, and the single information processing terminal 6 are provided, but two or more log monitoring servers 2, two or more application servers 3, two or more LaaS servers 4, and two or more information processing terminals 6 may be provided. In addition, for example, functions of the log monitoring server 2, the application server 3, and the LaaS server 4 may be realized by a single server.

<Example of an Attack Against the LaaS>

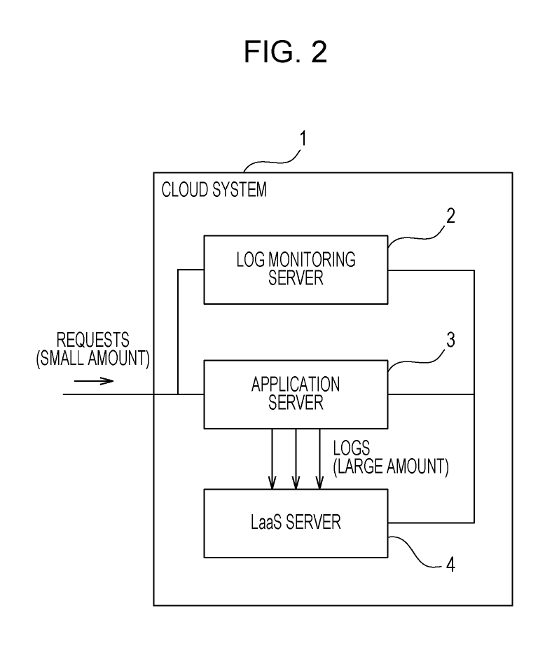

Examples of an attack against the LaaS are described below with reference to drawings. FIG. 2 is a diagram illustrating the first example of an attack against the LaaS. In the first example, the number of requests to the application in the application server 3 is small, but a large number of logs are output through the application. For example, when an application has been developed by which a program for executing an infinite loop is implemented, a large number of logs may be output through the application for a small number of requests.

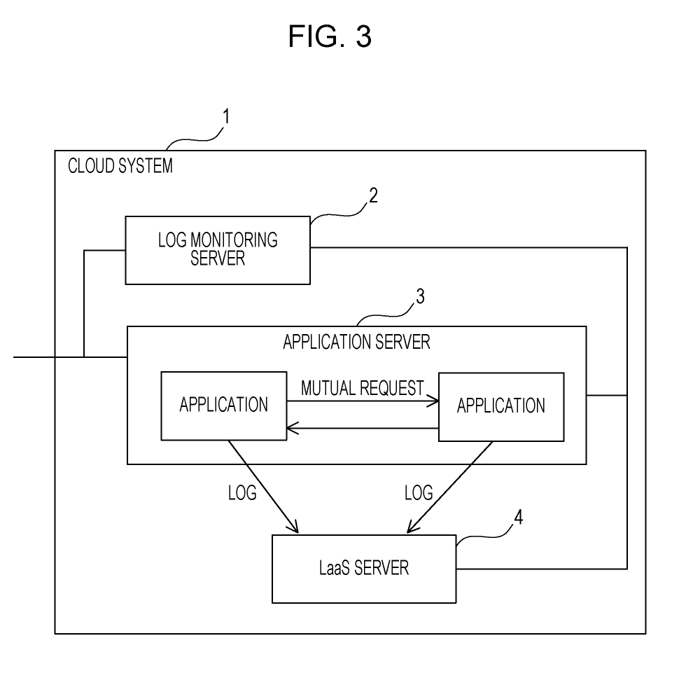

FIG. 3 is a diagram illustrating the second example of an attack against the LaaS. In the second example, two or more applications are stored in the application server 3. In addition, it is assumed that the two or more applications have been developed so as to repeatedly transmit and receive requests to and from each other.

In the example of FIG. 3, when a large number of requests are mutually transmitted and received between the applications, a large number of logs are output to the LaaS server 4 from the applications regardless of a request amount from the outside of the cloud system 1.

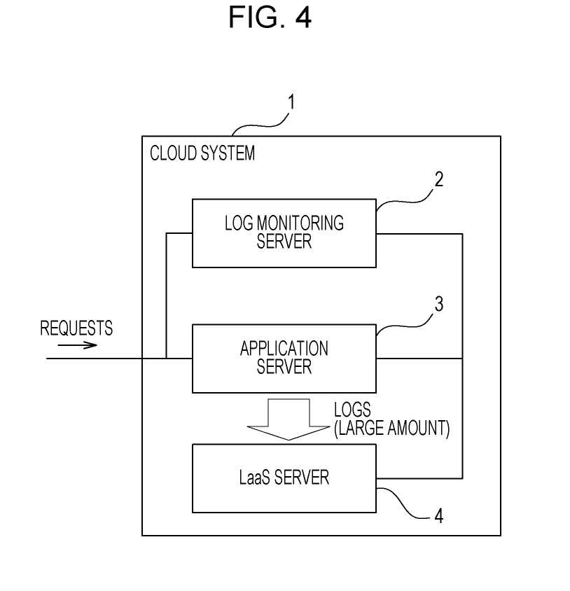

FIG. 4 is a diagram illustrating the third example of an attack against the LaaS. In the first example, for a single request to the application in the application server 3, a large amount of logs (logs each having a large data amount) are output through the application. In the third example, for example, it is assumed that an application has been developed through which a large amount of logs are output for a specific request.

In the example illustrated in FIGS. 2 to 4, it is desirable that the log monitoring server 2 determine whether the log output is caused by an attack, and deal with the determination result. However, a large amount or a large number of logs are likely to be output through the application regardless of the presence or absence of malicious intent, and therefore, a wrong decision may be made when the presence or absence of an attack is determined in accordance with only a log output amount or the number of log outputs.

For example, because the number of requests to the application depends on the number of end users who utilize the application, the number of log outputs depends on the number of end users. However, the cloud operator may not determine the number of end users. Thus, it is difficult for the log monitoring server 2 to determine the presence or absence of an attack in accordance with only the number of log outputs to the LaaS.

In addition, typically, the cloud operator does not have the authority to refer to the contents of logs output by the service users, so that it is difficult for the log monitoring server 2 to determine the presence or absence of an attack in accordance with the contents of the requests.

In addition, the log monitoring server 2 may determine whether an attack has occurred, through behavior detection. For example, the log monitoring server 2 may monitors traffics and performs learning, as the behavior detection. In addition, the log monitoring server 2 may determine whether an attack has occurred by detecting an abnormal amount of requests or a request having an abnormal content that are normally not detected, in accordance with the learned contents.

However, through the application using the LaaS, a large amount or a large number of logs may be output even without a malicious intention. For example, when an unmalicious application through which a large amount or a large number of logs are output, such as an application having an advanced calculation function or the like, is deployed to the cloud system 1, the log monitoring server 2 learns, through behavior detection, that a log output amount of the application is normal. In addition, the log monitoring server 2 may determine a malicious application to be unmalicious by mistake when logs the amount of which is similar to the above-described unmalicious application through which a large amount or a large number of logs are output, are output through the malicious application after the learning.

As a measure for an attack against the LaaS, FW that restricts a request from a specific IP address may be provided between the cloud system 1 and the network 5. However, if a malicious user deploys an application intended for an attack against the LaaS to the cloud system 1 with the regular procedure, the application may attack the LaaS without going through the FW. Thus, the FW is not a sufficient measure against an attack to the LaaS.

In addition, examples of the measure against a DoS attack include a method in which a request received at the application server 3 is limited by band control. However, the user may desires to refer to logs on a real-time basis. In this case, the band control may hinder the user's desire.

<Example of the Log Monitoring Server>

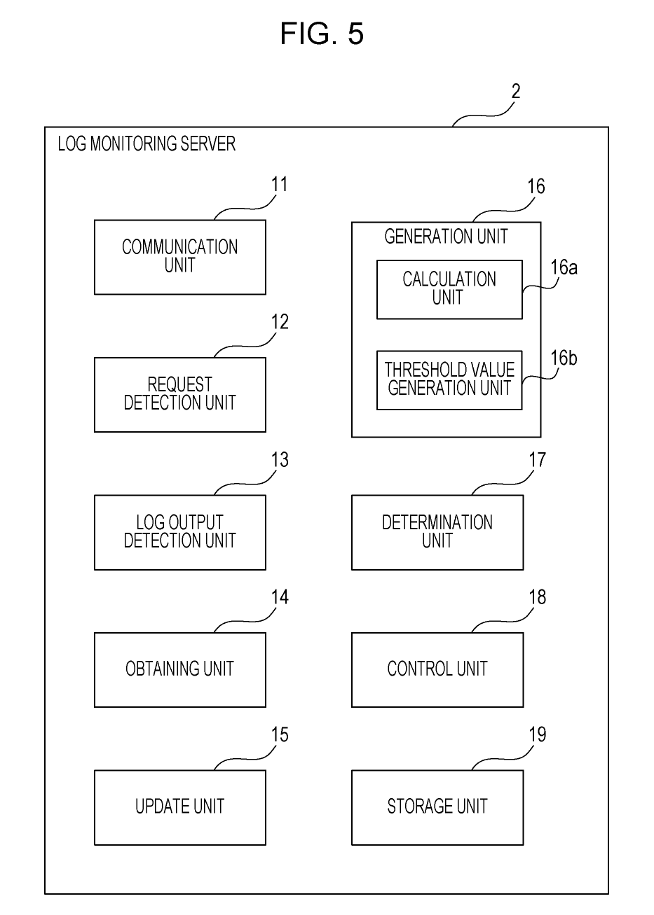

FIG. 5 is a diagram illustrating an example of the log monitoring server 2. The log monitoring server 2 includes a communication unit 11, a request detection unit 12, a log output detection unit 13, an obtaining unit 14, an update unit 15, a generation unit 16, a determination unit 17, a control unit 18, and a storage unit 19. The generation unit 16 includes a calculation unit 16a and a threshold value generation unit 16b.

The communication unit 11 transmits and receives various pieces of data to and from the application server 3 and the LaaS server 4.

The request detection unit 12 detects a request to the application server 3 from a transmission source other than a specific transmission source that has been registered in advance and updates the number of requests of application management information stored in the storage unit 19.

The transmission source other than the specific transmission source that has been registered in advance is, for example, an external device of the cloud system 1 (for example, the information processing terminal 6 in FIG. 1). For example, the request detection unit 12 determines whether a transmission source of the detected request is the specific transmission source that has been registered in advance, in accordance with a domain of the request transmission source.

The log output detection unit 13 detects a log output to the LaaS server 4 from the application server 3. In addition, the log output detection unit 13 updates the log output amount and the number of log outputs of the application management information stored in the storage unit 19.

The obtaining unit 14 obtains the number of requests from the transmission source other than the specific transmission source that has been registered in advance from among requests to the application, at specific time intervals. In addition, the obtaining unit 14 obtains one or both of an amount of logs that have been output through the application and the number of outputs of the logs, at specific time intervals. The obtaining unit 14 obtains, for example, the number of requests, the log output amount, and the number of log outputs that have been recorded in the application management information.

The update unit 15 calculates the number of log outputs per request and a log output amount per request, for each application, in accordance with the number of requests, the log output amount, and the number of log outputs that have been obtained by the obtaining unit 14.

In addition, the update unit 15 updates log output distribution information stored in the storage unit 19. The log output distribution information is information indicating distribution of the number of log outputs per request and the log output amount per request.

The generation unit 16 generates information on evaluation of software, in accordance with the number of requests, and one or all of the log output amount and the number of log outputs that have been obtained by the obtaining unit 14. The information on evaluation of software is a threshold value used to determine whether the application has been used for an attack against the LaaS server 4. In addition, the information on evaluation of software is a threshold value for one or a combination of the log output amount per request and the number of log outputs per request.

The generation unit 16 generates a threshold value that decreases as the maximum log storage amount that has been set in advance decreases. Processing operations of the calculation unit 16a and the threshold value generation unit 16b are described later in detail.

The determination unit 17 determines whether the application has been used for an attack against the LaaS server 4 by determining whether one of or a combination of the log output amount per request and the number of log outputs per request exceeds the generated threshold value.

The control unit 18 takes measures for the application when the determination unit 17 determines that the application has been used for an attack against the LaaS server 4. For example, the control unit 18 controls the operation of the application to be limited.

For example, the control unit 18 may stop the application that has been determined to be used for an attack against the LaaS server 4. The control unit 18 may limit a communication amount of the application that has been determined to be used for the attack by band control. The control unit 18 may take measures for the application so as to notify the cloud operator of the attack, notify the user of the attack, suppress storage of logs, stop a log output, obtain contents of logs, or the like.

The storage unit 19 stores application management information, log output amount classification information, log output number classification information, maximum log storage amount setting information, and log output distribution information. The pieces of information stored in the storage unit 19 are described later in detail.

<Example of the Pieces of Information Stored in the Storage Unit>

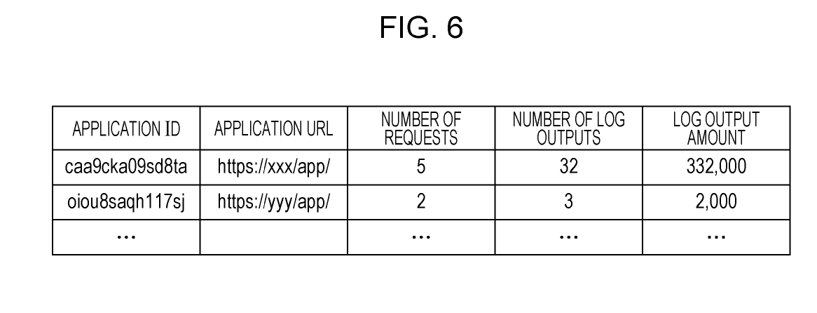

The pieces of information stored in the storage unit 19 are described below. FIG. 6 is a diagram illustrating an example of the application management information. As illustrated in FIG. 6, the application management information includes an application identification (ID) and an application uniform resource locator (URL). In addition, the application management information includes the number of requests, the number of log outputs, and a log output amount that have been associated with the corresponding application ID and application URL. A unit of the log output amount in the example of FIG. 6 is kilobyte (KB).

In addition, as described above, the number of requests is updated by the request detection unit 12. In addition, the number of log outputs and the log output amount are updated by the log output detection unit 13.

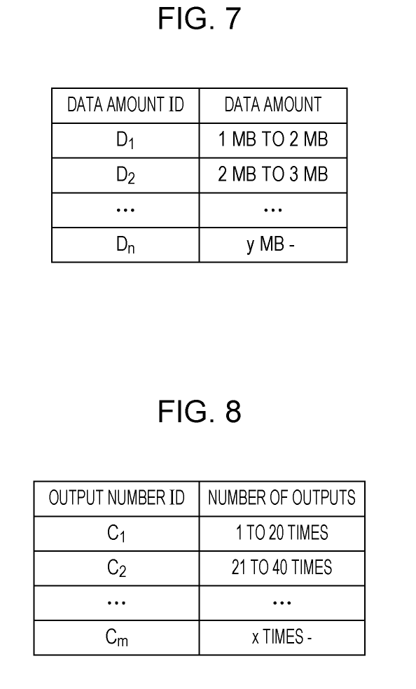

FIG. 7 is a diagram illustrating an example of the log output amount classification information. As illustrated in FIG. 7, in the log output amount classification information, a data amount ID and a log data amount output per request are associated with each other. The log output amount classification information is used to generate log output distribution information which is described later. The log monitoring server 2 may update the range of a data amount corresponding to each data amount ID depending on the actual output status of logs as appropriate.

FIG. 8 is a diagram illustrating an example of the log output number classification information. As illustrated in FIG. 8, in the log output number classification information, an output number ID and the number of log outputs per request are associated with each other. The log output number classification information is used to generate the log output distribution information which is described later. The log monitoring server 2 may update the range of the number of log outputs corresponding to each output number ID depending on the output status of logs as appropriate.

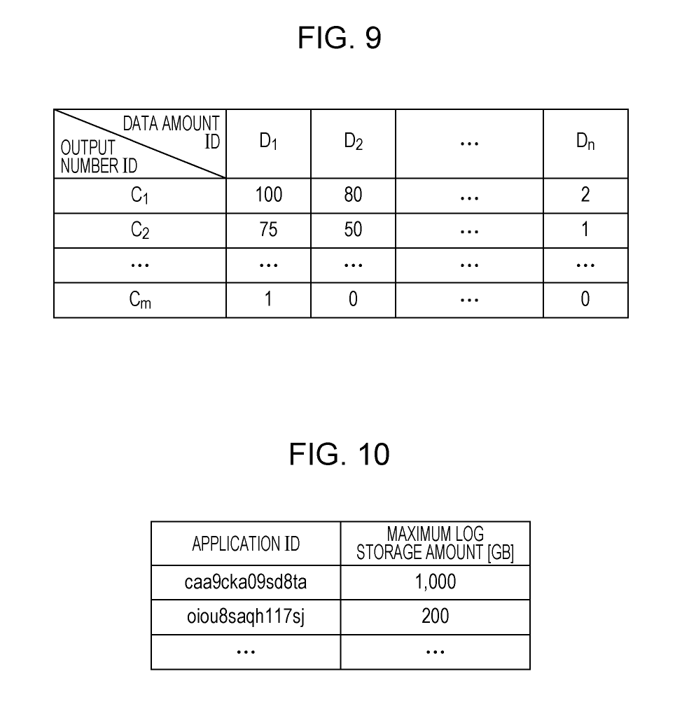

FIG. 9 is a diagram illustrating an example of the log output distribution information. A numeric value in the log output distribution information illustrated in FIG. 9 indicates the number of occurrence times for a combination of a data amount ID and an output number ID. For example, the log output distribution information indicates the number of occurrence times, in each of which output number ID is C1, and the data amount ID is D1 in a specific time period, is 100.

FIG. 10 is a diagram illustrating an example of the maximum log storage amount setting information. As illustrated in FIG. 10, in the maximum log storage amount setting information, a maximum log storage amount [gigabyte (GB)] and an application ID are associated with each other. The maximum log storage amount is set in advance, for example, by the user of the cloud system 1 at the time of contract.

For example, when the user uses an application through which advanced calculation is performed, a large amount of pieces of processing are executed for a single request through the application, such that it is assumed that a large amount of logs are output. When a large amount of logs have been output, it is assumed that that the user sets the maximum log storage amount at a large value.

In addition, charge may be increased in order to increase the maximum log storage amount, such that the maximum storage amount is likely to be set at a small value in a malicious application. Thus, the log monitoring server 2 may use the maximum log storage amount for determining whether the application has been used for an attack.

<Example of Processing of the Generation Unit>

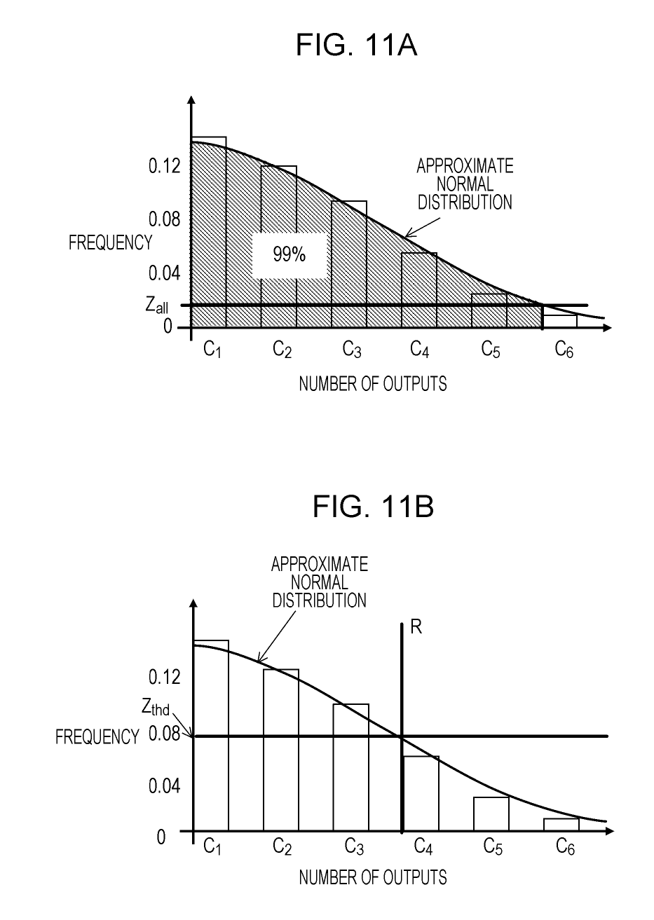

An example of the processing of the generation unit 16 is described below. FIGS. 11A and 11B are diagrams illustrating an example of a generation method of a threshold value for the number of outputs. FIG. 11A is a two-dimensional histogram illustrating a relationship between the number of outputs and frequency.

The calculation unit 16a calculates frequency by dividing a total of the number of occurrence times of the combination for each output time ID (C₁ to C₆) of the log output distribution information by a total of all values of the log output distribution information. The calculation unit 16a creates a histogram illustrated in FIG. 11A in accordance with the calculated frequency. In addition, the calculation unit 16a calculates an approximate normal distribution by assuming that, in the created histogram, the number of outputs has a similar distribution even in an area of negative values.

In addition, the calculation unit 16a sets, as a reference value Zₐₗₗ, frequency at a position where a ratio of a value that has been obtained by combining frequency in sections of some output number IDs becomes 99% to the cumulative value of frequency of sections of all of the output number IDs in the normal distribution. The reference value Zₐₗₗ may be frequency at a position other than the position where the ratio of the value obtained by combining frequency of sections becomes 99% to the cumulative value of frequency of all of the sections. The example illustrated in FIG. 11A indicates that a ratio of frequency accumulation of C1 to C5 to frequency accumulation of C1 to C6 is 99%.

In addition, the calculation unit 16a calculates an average value C_{avg} of the maximum log storage amounts of the applications in accordance with the maximum log storage amount setting information stored in the storage unit 19. In addition, the calculation unit 16a calculates “Zₐₗₗ×C_{avg}” and sets the calculation result as a constant a.

FIG. 11B is an example of a two-dimensional histogram illustrating a relationship between the number of outputs and frequency of a target application for which a threshold value is generated. Hereinafter, the target application for which a threshold value is generated may be simply referred to as a target application. The threshold value generation unit 16b obtains a maximum log storage amount C of the target application from the maximum log storage amount setting information stored in the storage unit 19.

In addition, the threshold value generation unit 16b calculates “a/C” and sets the calculation result as a reference value Z_{thd} of the target application. In addition, the threshold value generation unit 16b sets the number of log outputs per request at an intersection of a straight line indicating the threshold value Z_{thd} and the normal distribution as a threshold value R used for determining whether the application has been used for an attack against the LaaS.

In the example illustrated in FIGS. 11A and 11B, generation of a threshold value for the number of log outputs per request is described, but the generation unit 16 may generate a threshold value for a log output amount per request by a similar method.

As described above, the reference value Z_{thd} is obtained by “a/C”, such that the reference value Z_{thd} becomes larger as the maximum log storage amount C of the target application becomes smaller. In addition, as illustrated in FIG. 11B, the threshold value R becomes smaller as the reference value Z_{thd} becomes larger. As described above, in a malicious application, the maximum log storage amount C is likely to be set at a small value. That is, the log monitoring server 2 may easily detect that the application has been used for an attack against a server that stores logs by generating a smaller threshold value R as the maximum storage amount C becomes smaller.

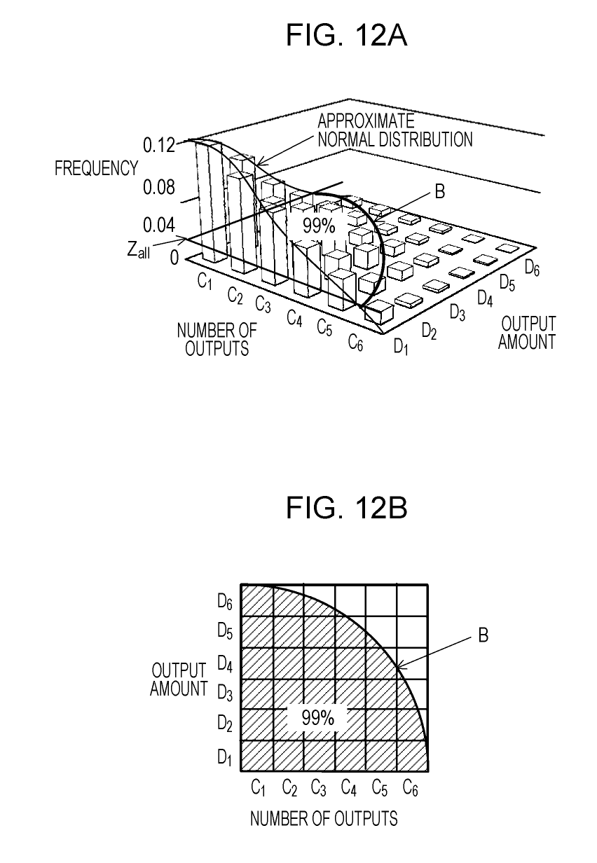

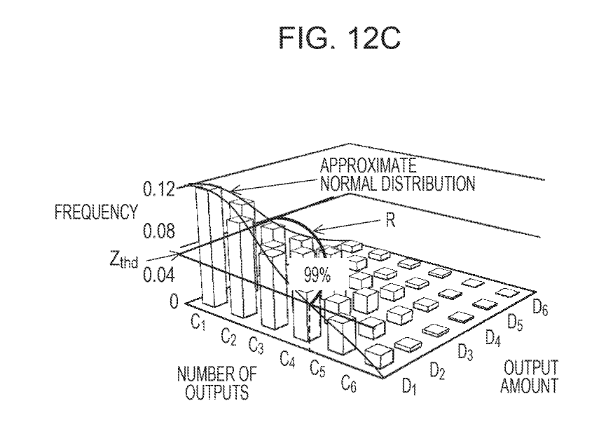

FIGS. 12A to 12C are diagrams illustrating an example of a generation method of a threshold value for a pair of the number of log outputs and a log output amount. FIG. 12A is a diagram illustrating a three-dimensional histogram indicating a relationship frequency and a pair of the number of log outputs and a log output amount. FIG. 12B is a diagram illustrating a relationship between frequency and a pair of the number of log outputs and a log output amount, which corresponds to FIG. 12A.

The calculation unit 16a calculates frequency by dividing a value of each pair of a data amount ID (C₁ to C₆) and an output number ID (D₁ to D₆) of the log output distribution information illustrated in FIG. 9 by a total of all values of the log output distribution information.

The calculation unit 16a creates a three-dimensional histogram illustrated in FIG. 12A in accordance with the calculated frequency. In addition, the calculation unit 16a calculates an approximate normal distribution by assuming that, in the created three-dimensional histogram, the number of log outputs and the log output amount have a similar distribution even in an area of negative values.

In addition, the calculation unit 16a sets, as the reference value Zₐₗₗ, frequency at a position where a ratio of a value that has been obtained by combining frequency in sections of some pairs of output number IDs and data amount IDs becomes 99% to the cumulative value of frequency of sections of all of the pairs of output number IDs and data amount IDs in the normal distribution. In the example illustrated in FIG. 12A, frequency in a curve B is the reference value Zₐₗₗ.

In addition, the calculation unit 16a calculates an average value C_{avg} of maximum log storage amounts of the applications in accordance with maximum log storage amount setting information stored in the storage unit 19. In addition, the calculation unit 16a calculates “Zₐₗₗ×C_{avg}” and sets the calculation result as constant a.

FIG. 12C is a diagram illustrating an example of a three-dimensional histogram used when a threshold value for a pair of the number of log outputs and a log output amount of a target application is generated. The threshold value generation unit 16b obtains a maximum log storage amount C of the target application from the maximum log storage amount setting information stored in the storage unit 19.

In addition, the threshold value generation unit 16b calculates “a/C”, and sets the calculation result as the reference value Z_{thd} of the target application. In addition, the threshold value generation unit 16b sets a curve R where a plane that passes through the threshold value Z_{thd} and the normal distribution intersect, as a threshold value used to determine whether the target application has been used for an attack against the LaaS server 4.

The threshold value is a threshold value for a pair of the number of log outputs per request and a log output amount per request. For example, in FIG. 12C, when at least some of pairs of the number of log outputs and the log output amounts are outside of the threshold value R (outside of the hatched range), the determination unit 17 may determine that the application has been used for an attack.

In the example of FIGS. 12A to 12C, similar to the example illustrated in FIGS. 11A and 11B, the reference value Z_{thd} is obtained by “a/C”, such that the reference value Z_{thd} becomes larger as the maximum log storage amount C of the target application becomes smaller. In addition, as illustrated in FIG. 12C, the range of the threshold value R becomes smaller as the reference value Z_{thd} becomes larger. Thus, it becomes easier to detect that the application has been used for an attack against a server that stores logs.

In addition, the log monitoring server 2 may easily detect an attack by which both the number of log outputs and a log output amount are caused to be increased, by using both a log output amount per request and the number of log outputs per request.

<Flowchart Illustrating a Flow of Processing According to the Embodiment>

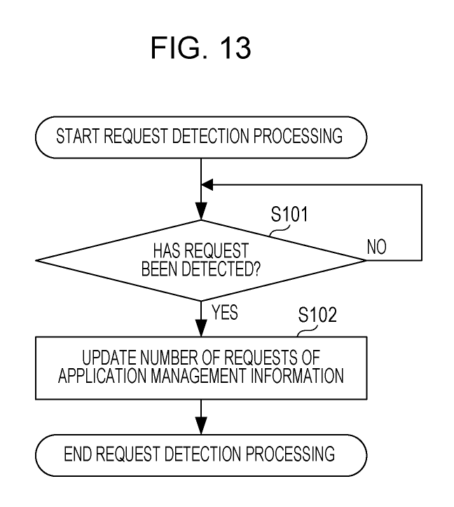

FIG. 13 is a flowchart illustrating an example of request detection processing. When the request detection unit 12 has detected a request to the application server 3 from a transmission source other than a specific transmission source that has been registered in advance (YES in Step S101), the request detection unit 12 updates the number of requests in application management information stored in the storage unit 19 (Step S102).

When the request detection unit 12 does not detect a request to the application server 3 from the transmission source other than the specific transmission source that has been registered in advance (NO in Step S102), the request detection unit 12 waits for detection of a request.

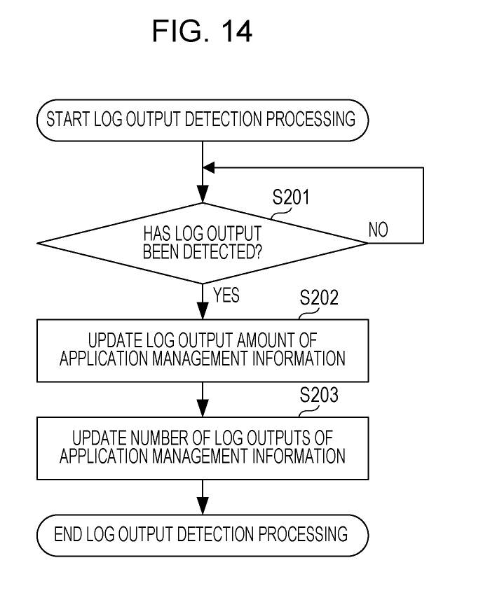

FIG. 14 is a flowchart illustrating an example of log output detection processing. When the log output detection unit 13 has detected a log output to the LaaS server 4 from the application server 3 (YES in Step S201), the log output detection unit 13 updates the log output amount in the application management information stored in the storage unit 19 (Step S202). In addition, the log output detection unit 13 updates the number of log outputs in the application management information (Step S203).

When the log output detection unit 13 does not detect a log output to the LaaS server 4 from the application server 3 (NO in Step S201), the log output detection unit 13 waits for detection of a log output.

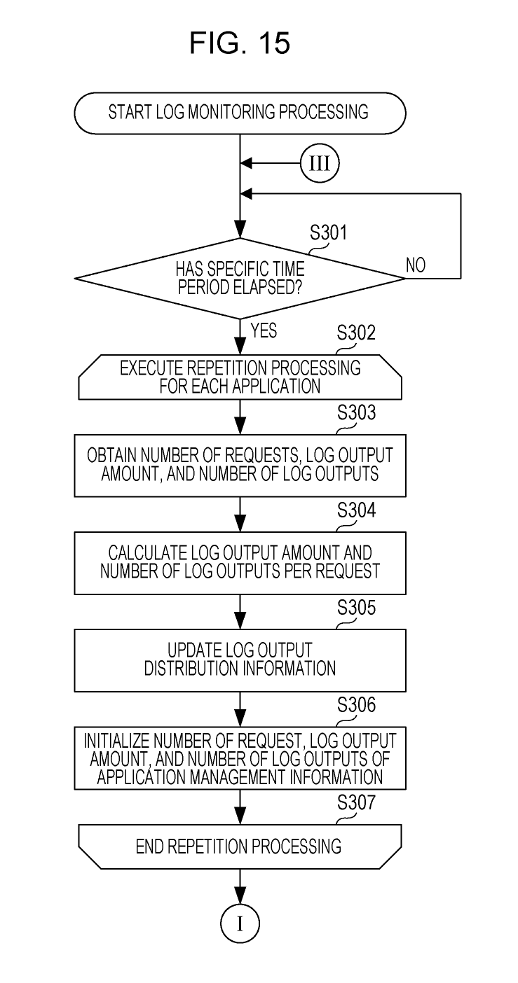

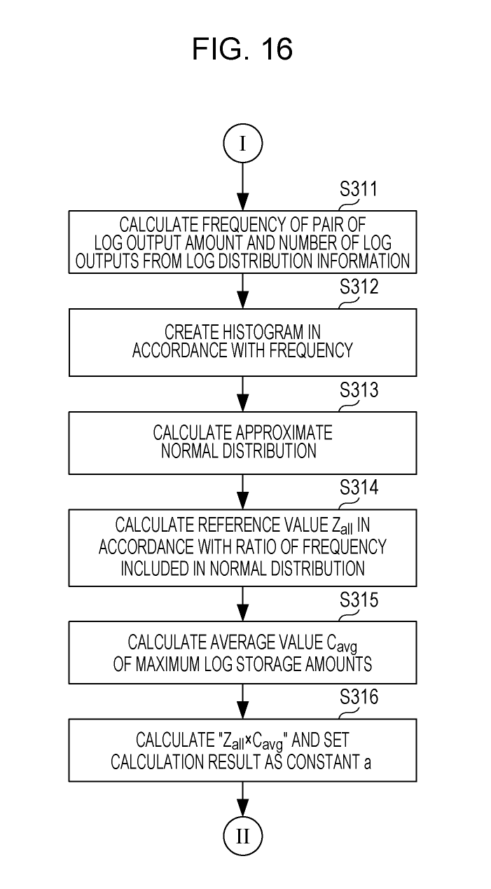

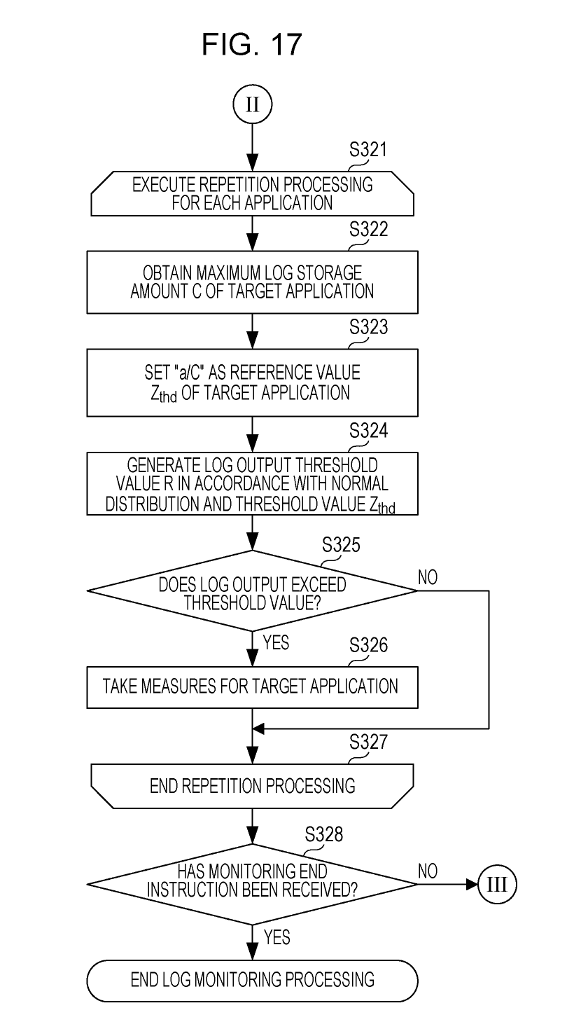

FIGS. 15 to 17 are flowcharts illustrating an example of log monitoring processing. The log monitoring server 2 determines whether a specific time period has elapsed since the previous log monitoring processing (for example, since a time point at which “YES” had been determined in Step S301 of the previous log monitoring processing) (Step S301). When the specific time period has elapsed (YES in Step S301), the log monitoring server 2 starts repetition processing for each application (Step S302).

The obtaining unit 14 obtains the number of requests from a transmission source other than the specific transmission source that has been registered in advance from among requests to the target application, and one of or both an amount of logs that has been output through the application and the number of outputs of the logs (Step S303). For example, the obtaining unit 14 obtains the number of requests, a log output amount, and the number of log outputs of the target application, which have been recorded in the application management information.

The update unit 15 calculates the number of log outputs per request and a log output amount per request, in accordance with the number of requests, the log output amount, and the number of log outputs that have obtained by the obtaining unit 14 (Step S304).

In addition, the update unit 15 updates the log output distribution information stored in the storage unit 19 in accordance with the calculation result of Step S304 (Step S305). The update unit 15 updates the log output distribution information (for example, FIG. 9), for example, in accordance with the calculation result of Step S304, the log output amount classification information (for example, FIG. 7), and the log output number classification information (for example, FIG. 8).

In addition, the update unit 15 initializes the number of requests, the log output amount, and the number of log outputs of the target application in the application management information (Step S306). For example, the update unit 15 sets, at zero, the number of requests, the log output amount, and the number of log outputs of the target application in the application management information. The log monitoring server 2 ends the repetition processing when the processing of Steps S303 to S306 is completed for all of the applications included in the application management information (Step S307).

The calculation unit 16a calculates frequency by dividing a value of each pair of a data amount ID and an output number ID of the log output distribution information by a total of all values in the log output distribution information (Step S311). When the calculation unit 16a generates a threshold value for the number of log outputs, the calculation unit 16a may calculate frequency by dividing a total of the total number of occurrence times for each output number ID of the log output distribution information by a total of all of the values of the log output distribution information. When the calculation unit 16a generates a threshold value for a log output amount, the calculation unit 16a may calculate frequency by dividing a total of the number of occurrence times for each output amount ID of the log output distribution information by the total of all of the values of the log output distribution information.

The calculation unit 16a creates a histogram in accordance with the calculated frequency (Step S312). In addition, the calculation unit 16a calculates an approximate normal distribution by assuming that, in the created histogram, the number of outputs has a similar distribution even in an area of negative values (Step S313).

The calculation unit 16a calculates a reference value Zₐₗₗ in accordance with the ratio of frequency included in the normal distribution (Step S314). For example, the calculation unit 16a sets, as a reference value Zₐₗₗ, frequency at a position where the ratio of frequency becomes a specific ratio to the cumulative value of frequency in the normal distribution.

In addition, the calculation unit 16a calculates an average value C_{avg} of the maximum log storage amounts of the applications in accordance with the maximum log storage amount setting information stored in the storage unit 19 (Step S315). In addition, the calculation unit 16a calculates “Zₐₗₗ×C_{avg}” and sets the calculation result as a constant a (Step S316).

The log monitoring server 2 starts repetition processing for each of the applications (Step S321). The threshold value generation unit 16b obtains the maximum log storage amount C of the target application from the maximum log storage amount setting information stored in the storage unit 19 (Step S322).

In addition, the threshold value generation unit 16b calculates “a/C” and sets the calculation result as a reference value Z_{thd} of the target application (Step S323). In addition, the threshold value generation unit 16b sets a threshold value R used to determine whether the application has been used for an attack against LaaS, in accordance with the threshold value Z_{thd} and the normal distribution that has been calculated in Step S313 (Step S324).

In addition, when the threshold value generation unit 16b generates a threshold value R for one of the number of log outputs and a log output amount, the threshold value generation unit 16b sets, as the threshold value R, the number of log outputs at an intersection of the straight line indicating the threshold value Z_{thd} and the normal distribution. When the threshold value generation unit 16b generates a threshold value for a pair of the number of log outputs per request and a log output amount per request, the threshold value generation unit 16b sets, as a threshold value, a curve R where a plane that passes through the threshold value Z_{thd} and the normal distribution intersect (see FIG. 12C).

The determination unit 17 determines whether one of or a combination of the log output amount per request and the number of log outputs per request exceeds the generated threshold value (Step S325). When “YES” is determined in Step S325, the control unit 18 takes measures for the application (Step S326). For example, the control unit 18 controls an operation of the application to be limited.

When the log monitoring server 2 executes the processing of Steps S322 to S326 for all of the applications, the log monitoring server 2 ends the repetition processing (Step S327). When the log monitoring server 2 receives a monitoring end instruction from the cloud operator or the like (YES in Step S328), the log monitoring server 2 ends the monitoring processing. When the log monitoring server 2 does not receive a monitoring end instruction from the cloud operator or the like (NO in Step S328), the flow returns to Step S301.

As described above, the log monitoring server 2 determines whether the application has been used for an attack against the LaaS server 4, in accordance with one of or both of the log output amount per request and the number of log outputs per request, and takes measures for the application.

Thus, for example, the log monitoring server 2 may detect a malicious application (application used for an attack) through which a large amount or a large number of logs are outputs regardless of a small number of requests. In addition, the log monitoring server 2 suppresses determination of an unmalicious application to be malicious by mistake when a larger amount or a larger number of logs than the normal operation are output due to an increase in requests to the application. That is, the log monitoring server 2 may improve determination accuracy of a malicious application.

In addition, the log monitoring server 2 performs determination using the number of requests from an external transmission source (transmission source that is not registered in advance), which is outside the cloud system 1. Thus, the log monitoring server 2 may detect a malicious application when two or more applications in the cloud system 1 send requests to each other.

In addition, the log monitoring server 2 generates a threshold value by using a maximum log storage amount that has been set by the user. Thus, the log monitoring server 2 may predict an amount of logs that may be output through an application to some extent and suppress determination of an application through which many logs are steadily output to be a malicious application by mistake.

In addition, the maximum log storage amount is likely to be set at a small value in a malicious application, such that the log monitoring server 2 may further improve determination accuracy of a malicious application by using the maximum log storage amount.

<Example of a Hardware Configuration of the Log Monitoring Server>

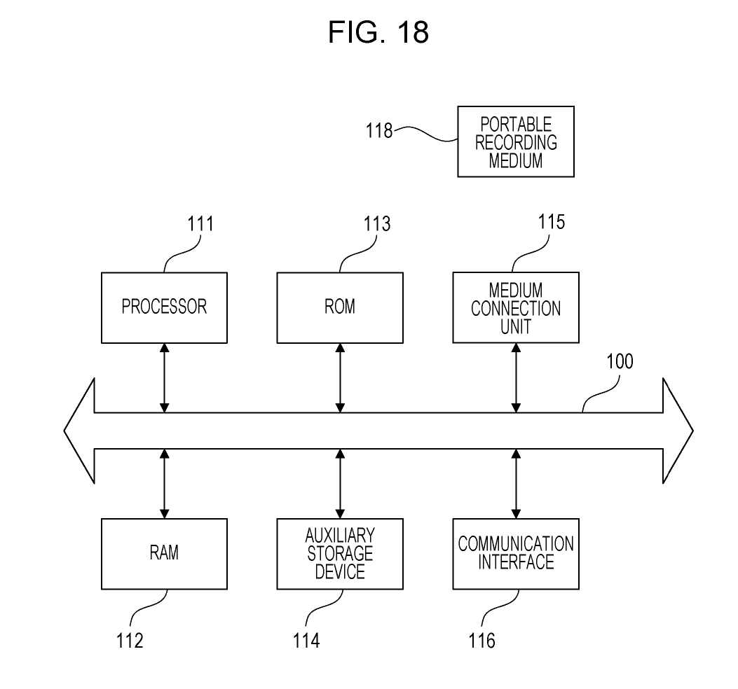

An example of the hardware configuration of the log monitoring server 2 is described below with reference to the example of FIG. 18. As illustrated in FIG. 18, a processor 111, a random access memory (RAM) 112, and a read only memory (ROM) 113 are coupled to each other through a bus 100. In addition, an auxiliary storage device 114, a medium connection unit 115, and a communication interface 116 are coupled to each other through the bus 100.

The processor 111 executes a program that has been deployed to the RAM 112. As the program to be executed, a software evaluation program that executes the processing according to the embodiment may be applied.

The ROM 113 is a nonvolatile storage device that stores the program deployed to the RAM 112. The auxiliary storage device 114 is a storage device that stores various pieces of information, and for example, a hard disk drive, a semiconductor memory, or the like may be applied to the auxiliary storage device 114. The medium connection unit 115 is provided so as to be allowed to be coupled to a portable recording medium 118.

As the portable recording medium 118, a portable memory, an optical disk (for example, a compact disc (CD) or a digital versatile disc (DVD)), a semiconductor memory, or the like may be applied. The software evaluation program used to execute the processing according to the embodiment may be recorded in the portable recording medium 118.

The storage unit 19 illustrated in FIG. 5 may be realized by the RAM 112, the auxiliary storage device 114, or the like. The communication unit 11 illustrated in FIG. 5 may be realized by the communication interface 116. The request detection unit 12, the log output detection unit 13, the obtaining unit 14, the update unit 15, the generation unit 16, the determination unit 17, and the control unit 18 illustrated in FIG. 5 may be realized when the provided software evaluation program is executed by the processor 111.

Each of the RAM 112, the ROM 113, the auxiliary storage device 114, and the portable recording medium 118 is an example of a computer-readable tangible storage medium. These tangible storage mediums do not include a transitory medium such as signal carrier waves.

### OTHER

The technology discussed herein is not limited to the above-described embodiments, and applies various configurations or embodiments within the range without departing from the gist of the technology discussed herein.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A software evaluation method executed by a computer, the method comprising:
obtaining a number of requests from a transmission source other than a transmission source registered in advance from among requests to software, and at least one of an log output amount of logs output through the software and a number of log outputs of the logs; and
generating information on evaluation of the software in accordance with the obtained number of requests and at least one of the obtained log output amount and the obtained number of log outputs.

2. The software evaluation method according to claim 1, wherein the information on evaluation of the software is a threshold value used to determine whether the software is used for an attack against a server that stores the logs, the threshold value being for a log output amount per request or a number of log outputs per request.

3. The software evaluation method according to claim 2 further comprising: limiting an operation of the software when the log output amount per request or the number of log outputs per request exceeds the corresponding threshold value.

4. The software evaluation method according to claim 1, wherein the information on the evaluation of the software is a threshold value used to determine whether the software is used for an attack against a server that stores the logs, the threshold value being for a combination of a log output amount per request and a number of log outputs per request.

5. The software evaluation method according to claim 4 further comprising: limiting an operation of the software when the combination of the log output amount per request and the number of log outputs per request exceeds the threshold value.

6. The software evaluation method according to claim 2, wherein the threshold value decreases as a maximum log storage amount set in advance decreases.

7. A software evaluation device comprising:
a memory; and
a processor coupled to the memory and the processor configured to:
obtain a number of requests from a transmission source other than a transmission source registered in advance from among requests to software, and at least one of an log output amount of logs output through the software and a number of log outputs of the logs, and
generate information on evaluation of the software in accordance with the obtained number of requests and at least one of the obtained log output amount and the obtained number of log outputs.

8. The software evaluation device according to claim 7, wherein the information on evaluation of the software is a threshold value used to determine whether the software is used for an attack against a server that stores the logs, the threshold value being for a log output amount per request or a number of log outputs per request.

9. The software evaluation device according to claim 8, the processor further configured to: limit an operation of the software when the log output amount per request or the number of log outputs per request exceeds the corresponding threshold value.

10. The software evaluation device according to claim 7, wherein the information on the evaluation of the software is a threshold value used to determine whether the software is used for an attack against a server that stores the logs, the threshold value being for a combination of a log output amount per request and a number of log outputs per request.

11. The software evaluation device according to claim 10, the processor further configured to: limit an operation of the software when the combination of the log output amount per request and the number of log outputs per request exceeds the threshold value.

12. The software evaluation device according to claim 8, wherein the threshold value decreases as a maximum log storage amount set in advance decreases.

13. A non-transitory computer-readable medium storing a software evaluation program that causes a computer to execute a process comprising:
obtaining a number of requests from a transmission source other than a transmission source registered in advance from among requests to software, and at least one of an log output amount of logs output through the software and a number of log outputs of the logs; and
generating information on evaluation of the software in accordance with the obtained number of requests and at least one of the obtained log output amount and the obtained number of log outputs.
